(19) United States
(12) Patent Application Publication
(10) Pub. No.: US 2011/0240894 A1
(43) Pub. Date: Oct. 6, 2011

(54) SOLENOID SPOOL VALVE

(75) Inventor: Hiroshi YASOSHIMA, Kariya-city (JP)

(73) Assignee: DENSO CORPORATION, Kariya-city (JP)

(21) Appl. No.: 13/076,805

(22) Filed: Mar. 31, 2011

(30) Foreign Application Priority Data
Apr. 1, 2010 (JP) 2010-85090

(51) Int. Cl. F16K 31/02

(52) U.S. Cl. 251/129.15

(57) ABSTRACT

A solenoid spool valve includes a sleeve, a spool, and a feed-back chamber. The sleeve has an input port and an output port. The input port receives fluid, and the output port is communicated with a control target chamber. The spool is received within the sleeve displaceably along a longitudinal axis of the sleeve to control a communication state of the input port and the output port. The feed-back chamber is communicated with the output port. The feed-back chamber applies pressure of output fluid to the spool in a valve closing direction for closing the solenoid spool valve. The sleeve has a feed-back passage opening at a passage between the output port and the control target chamber. The feed-back passage provides communication between the output port and the feed-back chamber.

### CROSS REFERENCE TO RELATED APPLICATION

This application is based on and incorporates herein by reference Japanese Patent Application No. 2010-85090 filed on Apr. 1, 2010.

### BACKGROUND OF THE INVENTION

1. Field of the Invention

The present invention relates to a solenoid spool valve that uses an electromagnetic actuator to actuate a spool valve.

2. Description of Related Art

JP-A-2009-275841 describes a conventional solenoid spool valve that is employed for an oil pressure control device for an automatic transmission of an automobile.

In other words, as shown in FIG. 4, a solenoid spool valve 100 has an electromagnetic actuator (not shown) and a spool valve 102. The spool valve 102 includes a sleeve 109 and a spool 110. The sleeve 109 has an input port 103, an output port 104, and a drain port 105. The spool 110 is received within the sleeve 109 displaceably in a longitudinal direction to control a communication state of each port. It should be noted that FIG. 4 shows an example of the solenoid spool valve 100 of an NIC (normally-closed) type, The spool 110 is urged by a return spring 113 in a valve closing direction (or toward the other axial side).

Also, the solenoid spool valve 100 defines therein a feed-back chamber 114, which is communicated with the output port 104, and which applies force in the valve closing direction to the spool 110 by using, as feed-back pressure, pressure of output fluid outputted from the output port 104.

When the spool 110 receives thrust force generated by the electromagnetic actuator, the spool 110 is displaced in a valve opening direction (or toward the one axial side). As an input sealing land 116 opens the input port 103 with the displacement of the spool 110, fluid flows into a distribution chamber 117 through the input port 103, and fluid flows out of the distribution chamber 117 to the output port 104.

In the solenoid spool valve 100, immediately after the opening of the valve, influence of fluid flowing from the input port 103 into the distribution chamber 117 may cause biasing force to the spool 110 in the valve closing direction. As a result, output responsivity may not be sufficiently achievable disadvantageously. The above disadvantage is not limited to the spool valve of the NIC type, but may be true for the spool valve of an N/O (normally-open) type.

In order to address the above disadvantages, JP-A-2007-309448 describes a technique, in which negative pressure is generated in the feed-back chamber 114 that generates force in the valve closing direction in order to improve the output responsivity.

In JP-A-2007-309448, a notch part, which slightly opens the input port, is provided to at least one of the input sealing land and the sleeve. Also, a feed-back port is provided immediately downstream of the notch part. Then, negative pressure is generated in the feed-back chamber by using a small flow channel between the notch part and the input port and by using flow of fluid (see FIG. 1 and HG. 5 in JP-A-2007-309448).

However, in the above technique, the shape of the notch part may influence the shape of the feed-back orifice formed at the feed-back port, and thereby the adjustable range (or a tunable range) of the feed-back orifice is unwantedly limited disadvantageously.

Also, in JP-A-2007-309448, there is formed an additional oil passage at a position apart from the solenoid spool valve. Negative pressure is caused in the oil passage. Then, negative pressure in the oil passage is introduced to the feed-back chamber (see FIG. 6 and FIG. 7 in JP-A-2007-309448).

However, in the above technique, it is impossible to achieve the function of generating negative pressure in the feed-back chamber just by the solenoid spool valve, and thereby the system may become complicated disadvantageously.

### SUMMARY OF THE INVENTION

The present invention is made in view of the above disadvantages. Thus, it is an objective of the present invention to address at least one of the above disadvantages.

To achieve the objective of the present invention, there is provided a solenoid spool valve that includes a sleeve, a spool, and a feed-back chamber. The sleeve has an input port and an output port. The input port receives fluid, and the output port is communicated with a control target chamber. The spool is received within the sleeve displaceably along a longitudinal axis of the sleeve to control a communication state of the input port and the output port. The feed-back chamber is communicated with the output port. The feed-back chamber applies pressure of output fluid, as feed-back pressure, to the spool in a valve closing direction for closing the solenoid spool valve. The sleeve has a feed-back passage opening at a passage between the output port and the control target chamber. The feed-back passage provides communication between the output port and the feed-back chamber.

### BRIEF DESCRIPTION OF THE DRAWINGS

The invention, together with additional objectives, features and advantages thereof, will be best understood from the following description, the appended claims and the accompanying drawings in which:

FIG. 1 is a cross-sectional view of a part of a solenoid spool valve according to the first embodiment of the present invention;

FIG. 2 is a cross-sectional view of a part of a solenoid spool valve according to the second embodiment of the present invention;

FIG. 3 is a cross-sectional view of a part of a solenoid spool valve according to the third embodiment of the present invention; and

FIG. 4 is a cross-sectional view of a solenoid spool valve of a conventional art.

### DETAILED DESCRIPTION OF PREFERRED EMBODIMENTS

### First Embodiment

### (Configuration of First Embodiment)

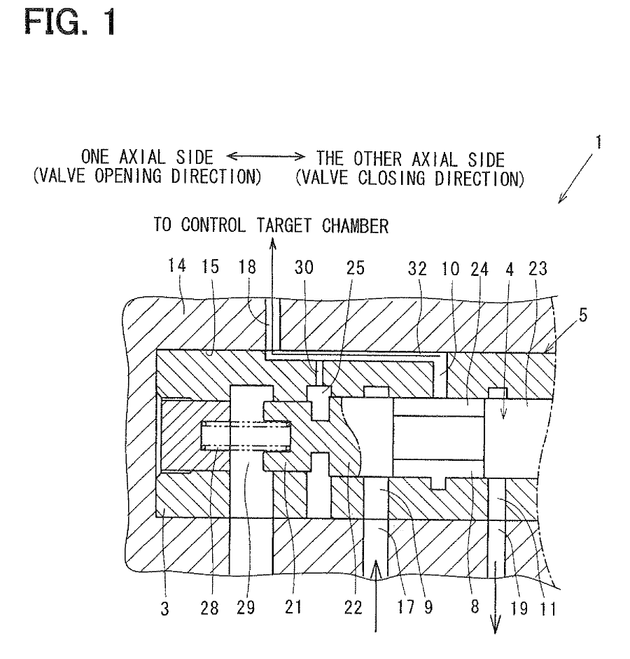

A configuration of a solenoid spool valve 1 according to the first embodiment of the present invention will be described with reference to FIG. 1.

The solenoid spool valve 1 is employed for hydraulic control of an oil pressure control device, such as an automatic transmission of an automobile, and includes an electromagnetic actuator (not shown) and a spool valve 5 having a sleeve 3 and a spool 4.

It should be noted that the present embodiment shows an application example for the solenoid spool valve 1 of an NIC (normally-closed) type. However, the present invention is applicable to a solenoid spool valve of an N/O (normally-open) type.

In the present embodiment, the left side in FIG. 1 corresponds to one axial side (one axial end) along the longitudinal axis of the solenoid spool valve 1. Also, the right side in FIG. 1 corresponds to the other axis side (the other axial end) along the longitudinal axis.

The electromagnetic actuator (not shown) is provided at the other axial end of the spool valve 5 along a longitudinal axis of the spool valve 5. In other words, the electromagnetic actuator is located on the other side of the spool valve 5 in the longitudinal direction. The electromagnetic actuator generates thrust force to the spool 4 such that the spool 4 is displaced in the longitudinal direction (or along the longitudinal axis). The thrust force is transmitted to the spool 4 through a shaft (not shown).

The sleeve 3 has a hollow cylindrical shape, and has at least one input port 9, at least one output port 10, and at least one drain port 11, all of which are communicated with the interior (or a valve chamber 8) of the sleeve 3.

It should be noted that the input port 9, the output port 10, and the drain port 11 are space apart from each other in the longitudinal direction. More specifically, the input port 9, the output port 10, the drain port 11 are arranged in this order from one end to the other end in the longitudinal direction.

The sleeve 3 is received within an insertion hole 15 of a fixation member 14.

The fixation member 14 defines flow channels 17, 18, 19 that open at an inner peripheral surface of the insertion hole 15 such that the flow channels 17, 18, 19 are communicated with the ports 9, 10, 11, respectively. The flow channel 18 is communicated with the output port 10, and is communicated with a control target chamber (not shown). The spool 4 has three lands that are in slidable contact with an inner peripheral surface of the sleeve 3. More specifically, a land 21, a land 22, and a land 23 are arranged in this order from the one end to the other end in the longitudinal direction.

The land 22 adjusts an opening degree of the input port 9, and the land 23 adjusts an opening degree of the drain port 11. There is defined a distribution chamber 24 between the land 22 and the land 23, and the distribution chamber 24 is communicated with the output port 10.

Also, there is defined a feed-back chamber 25 between the land 21 and the land 22. The feed-back chamber 25 is communicated with the output port 10, and generates feed-back pressure in accordance with pressure of output fluid when output fluid flows into the feed-back chamber 25. The land 21 has a diameter smaller than a diameter of the land 22. When feed-back pressure is applied to an area defined by the difference of the diameters between the land 21 and the land 22, the spool 4 receives biasing force in a valve closing direction for closing the solenoid spool valve 1 (or toward the other axial end in the longitudinal direction).

It should be noted that the spool 4 is urged by a spring 28 in the valve closing direction. The spring 28 is provided at the one axial end of the spool 4. There is defined a spring chamber 29 within the sleeve 3 at the one axial end of the spool 4 for receiving the spring 28.

### (Feature of First Embodiment)

In the solenoid spool valve 1 of the first embodiment, the sleeve 3 has a feed-back orifice (or a feed-back passage) 30 that opens at a passage between the output port 10 and the control target chamber. in other words, the feed-back orifice 30 opens to output flow through the output port 10 to the control target chamber. The feed-back orifice 30 is communicated with the feed-back chamber 25. The feed-back orifice 30 provides communication between the output port 10 and the feed-back chamber 25.

The flow channel 18 has an opening formed at the fixation member 14, and the opening of the flow channel 18 is located on the one axial side of the feed-back chamber 25 along the longitudinal axis. There is defined a communication passage 32 that provides communication between the output port 10 and the flow channel 18. The communication passage 32 is provided as a groove formed at an outer peripheral surface of the sleeve 3, and thereby the communication passage 32 is formed between the sleeve 3 and the insertion hole 15.

The sleeve 3 has the feed-back orifice 30, which opens in a radial direction, and which provides communication between the feed-back chamber 25 and the communication passage 32.

### (Operation of First Embodiment)

Operation of the solenoid spool valve 1 of the present embodiment will be described below.

When the electromagnetic actuator transmits the thrust force, which is applied in the direction toward the one axial end, to the spool 4 through the shaft (not shown), the spool 4 is displaced toward the one axial end against biasing force of the spring 28 and against biasing force by the feed-back chamber 25.

As the land 22 opens the input port 9 with the displacement of the spool 4, fluid flows into the distribution chamber 24 through the input port 9, and fluid flows into the output port 10 from the distribution chamber 24. Then, fluid (output fluid) that flows through the output port 10 is supplied to the control target chamber.

At this time, flow of output fluid from the output port 10 to the control target chamber is generated, and thereby the flow speed of the above flow causes negative pressure in the feed-back orifice 30. As a result, pressure in the feed-back chamber 25 is reduced.

### (Advantages of First Embodiment)

In the solenoid spool valve 1 of the present embodiment, the sleeve 3 defines the feed-back orifice 30 that opens at the communication passage 32 formed between the output port 10a and the control target chamber. The feed-back orifice 30 provides communication between the output port 10 and the feed-back chamber 25.

Due to the above, while output fluid flows from the output port 10 to the control target chamber, the flow of the output fluid generates negative pressure across the feed-back orifice 30, and thereby pressure in the feed-back chamber 25 is temporarily reduced. As a result, output responsivity of the solenoid spool valve 1 is improved advantageously.

Also, in the present embodiment, the shape of the feed-back orifice 3D is not limited to a certain shape, which is true in JP-A-2007-309448 in contrast. More specifically, the diameter and the length of the feed-back orifice 30 has substantial flexibility in design, and thereby an adjustable range or a tunable range of the feed-back orifice 30 is substantially wide advantageously compared with JP-A-2007-309448.

Also, the spool valve 5 itself defines therein the feed-back orifice 30. The feed-back orifice 30 causes negative pressure thereacross. Thus, the solenoid spool valve 1 of the present embodiment does not need additional components for the generation of negative pressure. As a result, it is possible to achieve a simple configuration of generating negative pressure to the feed-back chamber 25 only by the solenoid spool valve 1.

### Second Embodiment

### (Configuration of Second Embodiment)

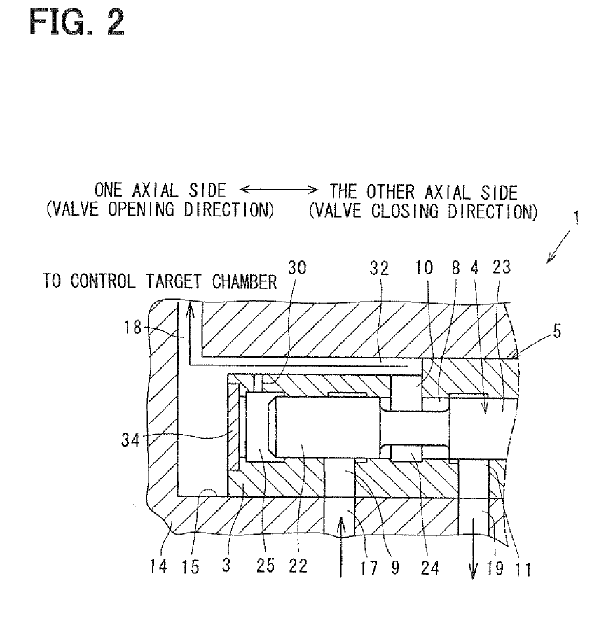

A configuration of the solenoid spool valve 1 of the second embodiment will be described with reference to FIG. 2, and parts different from the first embodiment will be mainly described.

In the solenoid spool valve 1 of the second embodiment, the feed-back chamber 25 is provided on the one axial side of the spool 4. Also, the one axial end of the feed-back chamber 25 is sealed by a sealing member 34 that is provided to close the opening of the sleeve 3 at the one axial end. The other axial end of the feed-back chamber 25 is sealed by the spool 4. As a result, a volume of the feed-back chamber 25 changes with displacement of the spool 4.

It should be noted that in contrast to the feed-back chamber 25 of the first embodiment, it is possible, in the present embodiment, to apply biasing force in the valve closing direction to the spool 4 by feed-back pressure without using the difference in the diameters between the land 21 and the land 22. As a result, the spool 4 of the second embodiment is not provided with the land 21.

It should be noted that in the second embodiment, a return spring is not provided at the one axial end of the spool 4. However, the return spring is provided at the other axial end of the spool 4 although it is not shown.

### (Advantages of Second Embodiment)

Due to the above, similarly to the first embodiment, while output fluid flows from the output port 10 to the control target chamber, the flow speed of the fluid generates negative pressure across the feed-back orifice 30, and thereby pressure in the feed-back chamber 25 is temporarily reduced. As a result, the output responsivity of the solenoid spool valve is improved advantageously.

Also, because the feed-back chamber 25 is defined within the sleeve 3 at the one axial end, and is formed at the one axial end of the spool 4 such that the volume of the feed-back chamber 25 changes with the displacement of the spool 4. As a result, the feed-back chamber 25 is capable of serving as a damper.

### Third Embodiment

### (Configuration of Third Embodiment)

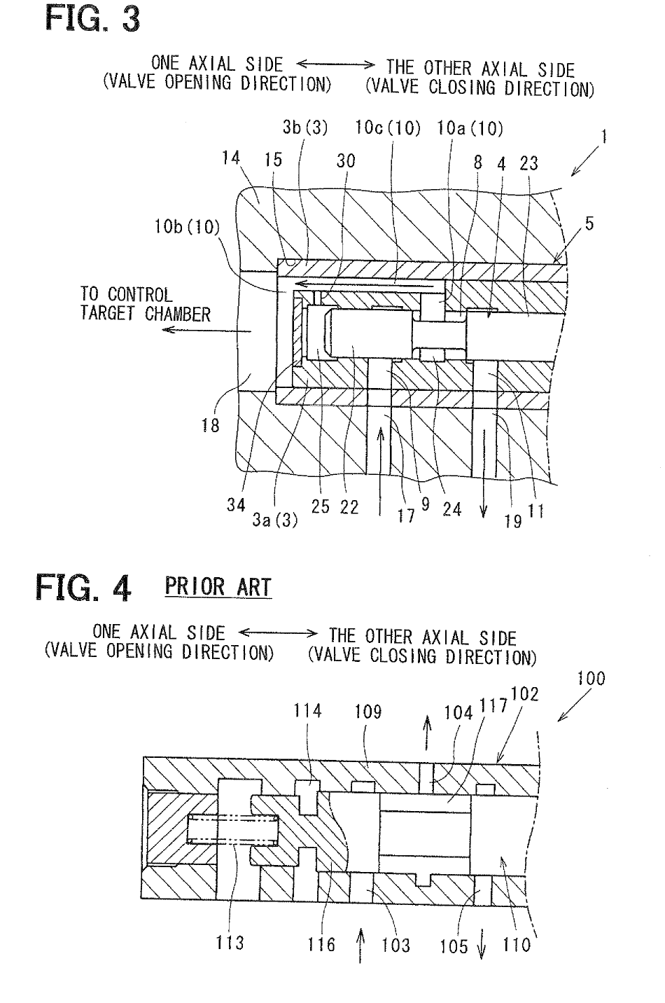

A configuration of the solenoid spool valve 1 of the third embodiment will be described with reference to FIG. 3, and the parts different from the second embodiment will be mainly described.

In the solenoid spool valve 1 of the third embodiment, the sleeve 3 includes an inner sleeve 3a and an outer sleeve 3b that is provided at an outer periphery of the inner sleeve 3a.

The inner sleeve 3a is press-fitted into the outer sleeve 3b such that a clearance between (a) an outer peripheral surface of the inner sleeve 3a and (b) an inner peripheral surface of the outer sleeve 3b is fluid-tightly sealed.

Also, the one axial end of the inner sleeve 3a is closed by the sealing member 34, and the one axial end of the outer sleeve 3b opens. The one axial end of the outer sleeve 3b further projects from the one axial end of the inner sleeve 3a along the longitudinal axis toward the one axial side (leftward in FIG. 3).

The sleeve 3 includes at least one input port 9, at least one output port 10, and at least one drain port 11 that are communicated with an interior (or the valve chamber 8) of the inner sleeve 3a.

The input port 9 and the drain port 11 are provided to extend through the walls of the inner sleeve 3a and the outer sleeve 3b in the radial direction.

The output port 10 includes an inlet-side opening 10a, an outlet-side opening 10b, and a communication passage 10c. The inlet-side opening 10a opens at the inner sleeve 3a or open adjacent the valve chamber 8. The outlet-side opening 10b opens at the one axial end of the sleeve 3. The communication passage 10c is provided between the inner sleeve 3a and the outer sleeve 3b to provide communication between the inlet-side opening 10a and the outlet-side opening 10b.

The communication passage 10c is a groove, which is communicated with the inlet-side opening 10a, and which is formed at the outer peripheral surface of the inner sleeve 3a to extend toward the one axial end of the inner sleeve 3a.

Also, in the present embodiment, the flow channel 18, which is communicated with the output port 10, is formed to open at the end of the insertion hole 15.

Due to the above configuration, output fluid of the output port 10 flows through the communication passage 10c from the inlet-side opening 10a toward the opening (the outlet-side opening 10b) of the one axial end of the outer sleeve 3b. Thus, output fluid is supplied to the flow channel 18 through the outlet-side opening 10b. Also, the feed-back orifice 30, which is communicated with the feed-back chamber 25, opens to the communication passage 10c of the output port 10 such that feed-back orifice (feed-back passage) 30 provides communication between the output port 10 and the feed-back chamber 25.

The feed-back chamber 25 is provided at the one axial end of the spool 4 within the one axial end portion of the inner sleeve 3a. Also, the one axial end of the feed-back chamber 25 is sealed by the sealing member 34.

### (Advantages of Third Embodiment)

In the third embodiment, advantages similar to those in the second embodiment are achievable.

### (Modification)

The embodiment of the solenoid spool valve 1 is not limited to the above embodiments, and thereby various modifications may be applicable. For example, in the first and second embodiments, the flow channel 18 is provided on the one axial side of the feed-back chamber 25, and the communication passage 32 is provided to connect the opening of the flow channel 18 with the output port 10. The feed-back orifice 30 opens at the communication passage 32. The shape of the communication passage 32 and the position of the opening of the flow channel 18 are not limited to those described in the above embodiments provided that the feed-back orifice 30 formed in the sleeve 3 opens to the flow of output fluid from the output port 10 to the control target chamber.

Also, in the first and second embodiments, the communication passage 32 is provided by forming the groove at the outer peripheral surface of the sleeve 3 to provided communication between the output port 10 and the flow channel 18. However, the communication passage 32 may be alternatively provided by forming a groove at an inner peripheral surface of the insertion hole 15.

Also, in the third embodiment, the communication passage 10c between the inner sleeve 3a and the outer sleeve 3b is provided by forming the groove at the outer peripheral surface of the inner sleeve 3a. However, the communication passage 10c may be alternatively provided by forming a groove at an inner peripheral surface of ₜhe outer sleeve 3b.

Additional advantages and modifications will readily occur to those skilled in the art. The invention in its broader terms is therefore not limited to the specific details, representative apparatus, and illustrative examples shown and described.

What is claimed is:

1. A solenoid spool valve comprising:
a sleeve having:
an input port that receives fluid; and
an output port that is communicated with a control target chamber;
a spool that is received within the sleeve displaceably along a longitudinal axis of the sleeve to control a communication state of the input port and the output port; and
a feed-back chamber that is communicated with the output port, the feed-back chamber applying pressure of output fluid, as feed-back pressure, to the spool in a valve closing direction for closing the solenoid spool valve, wherein:
the sleeve has a feed-back passage opening at a passage between the output port and the control target chamber; and
the feed-back passage provides communication between the output port and the feed-back chamber.

2. The solenoid spool valve according to claim 1, wherein:
the feed-back chamber is provided at one axial end of the spool along the longitudinal axis;
the feed-back chamber has one axial end, which is sealed, and the other axial end, which is sealed by the spool; and
the feed-back chamber has a volume changeable with displacement of the spool.

3. The solenoid spool valve according to claim 1, wherein:
the feed-back passage is a feed-back orifice.

4. The solenoid spool valve according to claim 1, wherein:
the output fluid corresponds to fluid that flows through the output port.
